(19) United States
(12) Patent Application Publication
(10) Pub. No.: US 2010/0251857 A1
(43) Pub. Date: Oct. 7, 2010

(54) INSULATION STRIPPING DEVICE COMPRISING A CONTACT SENSOR AND ADJUSTMENT MEANS FOR AN INSULATION STRIPPING DEVICE

(76) Inventors: Steven Whittaker, Babenhausen (DE); Harald Biehl, Bensheim (DE)

Correspondence Address: BAKER & DANIELS LLP, 300 NORTH MERIDIAN STREET, SUITE 2700, INDIANAPOLIS, IN, 46204, US

(21) Appl. No.: 12/734,703

(22) PCT Filed: Nov. 6, 2008
(86) PCT No.: PCT/EP2008/009380

§ 371 Date: May 18, 2010

(30) Foreign Application Priority Data
Nov. 12, 2007 (DE) 10 2007 053 825.3

(51) Int. Cl. H02G 1/12; H01R 43/05

(52) U.S. Cl. 81/9.4; 30/123; 29/762; 29/593; 29/592

(57) ABSTRACT

The present invention relates to an insulation stripping device for the partial removal of a cable insulation, comprising at least one electrically conductive blade (100) for cutting through the cable insulation, and to an adjustment means for use with an insulation stripping device of this type. The present invention further relates to a method for finishing cables and to an adjustment method for adjusting a blade (100) position in an insulation stripping device. According to the present invention, the insulation stripping device comprises a capacitive sensor unit, which is connected to the conductive blade (100) and is formed in such a way as to emit an output signal if the conductive blade (100) contacts a electrical conductor (104) of the cable.

The present invention relates to an insulation stripping device for the partial removal of cable insulation, comprising at least one electrically conductive blade for cutting through the cable insulation, and an adjustment means for use with the insulation stripping device. The present invention further relates to a method for finishing cables and method for altering and adjusting a blade position in an insulation stripping device.

When manufactured cables are finished, an insulating coating that surrounds the cables ends will be removed, exposing an electrical conductor of the cable. This “insulation-stripping” conventionally takes place either in complex cable finishing stations, which often perform other functions such as crimping contacts, or alternatively by hand tools, which are operated directly by a user. These types of hand tools are well-known, as is evidenced from U.S. Pat. No. 6,324,945 B1 or U.S. Pat. No. 6,505,399 B2.

However, in known insulation stripping devices, overall cable and electrical conductor damage may occur because the positioning of the cutting means, i.e. blade positioning, is incorrectly adapted with respect to the cable dimensions. Hence, a blade may cut too deep, damaging the cable. This presents a danger, where weak spots arise, virtually unnoticed, in the vicinity of the cable end and may lead to fractures in the cable. The damage may even lead to failure of the components to which the cable is connected, leading to imperfections that may be difficult to locate and to repair.

An object of the present invention is therefore to improve an insulation stripping device in such a way to efficiently discover pre-existing damage to the cable and to increase the reliability of finished cable ends. An object of the present invention further involves increasing the consistency of existing insulation stripping devices.

The object of the invention is achieved by the subject matter of the independent claims. Advantageous improvements of the present invention are the subject matter of the dependent claims.

The present invention involves a capacitive sensor unit being connected to at least one of the electrically conductive blades, of an insulation stripping device, that emits an electrical output signal when the conductive blade contacts the conductor of the cable.

The concept of an E-field sensor for detecting contact, as disclosed in the international patent application WO 2007/106628 A2, is recognized.

According to the present invention, an A.C. voltage source applies an A.C. voltage to one or more blades of the insulation stripping device, and a detector unit detects the capacitance of at least one blade, which has been grounded. The cable, being stripped of insulation, represents a virtual ground, and the measured capacitance changes when the blades come into a conductive connection with the electrical conductor of the cable. In this case, according to the invention, an output signal is generated, which may be used as a warning signal or to stop subsequent manufacturing processes, depending on the application.

The improvements according to the invention advantageously lead to increased reliability and cost savings, as well as to a reduction in waste. Incorporating an adjustment means with the insulation stripping device may also save significant manufacturing time as well as improve any subsequent steps, such as a crimping process.

The present invention may be manufactured in such a way to be integrated with a hand tool, operating as an optical or acoustic warning means. The warning function would operate in such a way that a user is warned immediately if the cutting devices, i.e. blades, come into contact with the conductor of the cable.

Furthermore, the present invention may also be applied to complex cable finishing devices, which perform other functions, such as crimping contacts. Therefore, these other functions can be performed in addition to the cutting and insulation stripping of cables.

In an embodiment, a control signal may stop any subsequent processes when the capacitive sensor unit has detected contact between the blade and the electrical conductor. The control signal may also be used to provide output signals, such as an optical and/or acoustic warning function. The control signal can include either function as an alternative or use in combination. In this way, it can be determined in good time that the machine requires re-calibration. Once notified of the error, the user can perform the re-calibration immediately, thus saving time and material.

However, the present invention may also be used as a separate adjustment means in the calibration of an existing cable device, which are no longer retrofittable. According to the invention, a user connects the adjustment means to a short piece of the cable conductor, which is to be finished, and carries out the insulation stripping process with blades of the device to be adjusted. If the blade cuts to deep, and the conductor of the cable is damaged, the adjustment means provides a warning signal, such as a dialling tone. The user may then adjust the blade until the absence of the warning signal indicates proper calibration of the cutting blades, so no more damage will occur. In this way, the adjustment of the blade position of an already existing insulation stripping device can be simplified and more precise.

An adjustment means, such as a circuit, may be implemented in a crimping tool. The circuit may be incorporated into a hand-held, portable, battery-operated device. However, the adjustment means are not attached to the blades. Rather, a short portion of the provided cable conductor is connected to the test device by means of a clamp. This portion of cable conductor is then guided to the cutting device and then stripped of insulation. If one of the blades contacts the cable, a warning signal is generated.

Sensitivity controllers allow a user to adapt the sensor unit to the respective circumstances of the measurement environment.

The invention will now be explained in greater detail using the exemplary embodiments shown in the following figures. Like parts are provided with like reference numerals and like component references throughout. Furthermore, features or feature combinations from the different embodiments shown and described may also represent inventive solutions or solutions included within the invention.

### In the drawings:

FIG. 1 is a block diagram of an E-field sensor system used according to the present invention, in the usage environment thereof;

FIG. 2 is a circuit schematic diagram of a first embodiment of the present invention for use in an insulation stripping device;

FIG. 3 is a circuit schematic diagram of an output terminal, which can be connected to a crimping unit;

FIG. 4 is a circuit schematic diagram of a terminal, which can be connected to the blades;

FIG. 5 is a circuit schematic diagram of the grounding;

FIG. 6 is a layout sketch of a circuit board on which the circuit of FIGS. 2 to 5 can be mounted;

FIG. 7 is a back side view of the circuit board from FIG. 6;

FIG. 8 is a circuit schematic diagram of a second embodiment of a capacitive sensor unit, which can be integrated into a crimping tool.

The present invention is explained more precisely in the following paragraphs with reference to figures.

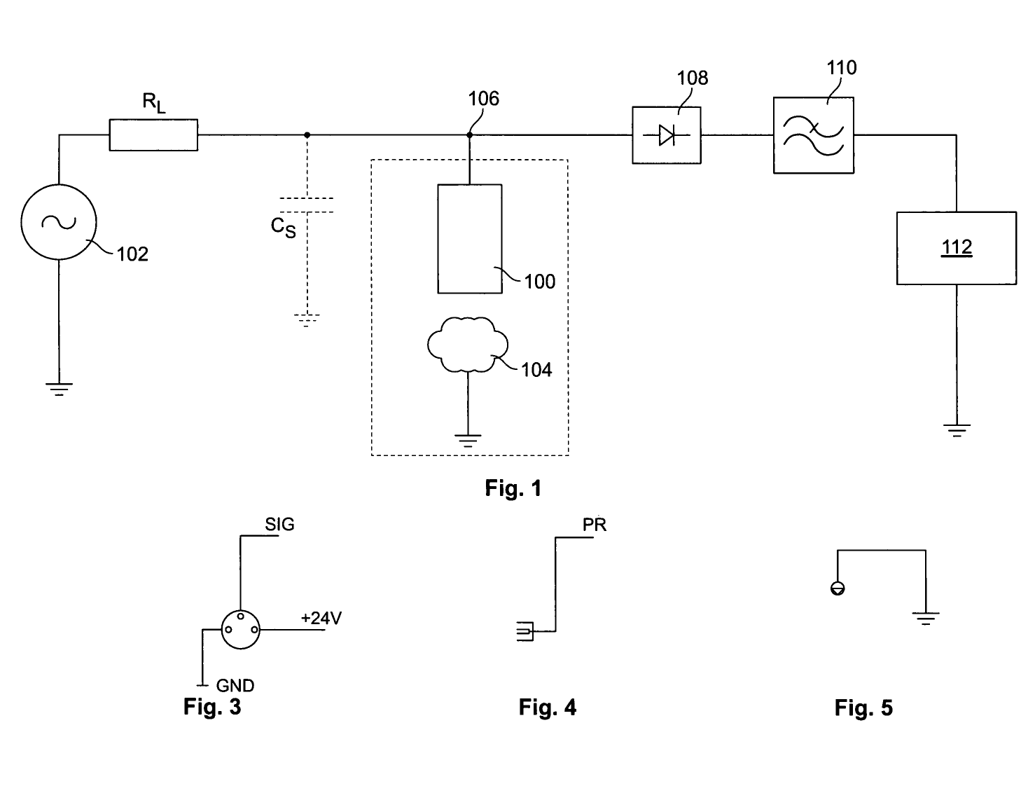

FIG. 1 illustrates the basic principle of the present invention, in block diagram form. According to the invention, one or more blades 100, of an insulation stripping device, are connected to an A.C. voltage generator 102 via a load resistor RL. The stray capacitance CS is represented with dashed lines.

The amplitude and phase of the sinusoidal voltage on the blade 100 are influenced by electrically conductive objects, such as a electrical conductor 104 of the cable, in the vicinity of the blade 100, which functions as an electrode. In the present embodiment, these objects are the electrically conductive core of the cable to be stripped of insulation. A type of capacitor forms between the blade 100 and the electrical conductor 104 of the cable, where the two components to act as a capacitor plate which carries a charge.

The voltage, which can be detected at the node 106, is inversely proportional to the capacitance between the blade, where the measurement is taken, and the electrical conductor 104 of the cable. A detector 108 and a low pass filter 110 guide the signal to an evaluation unit 112. The evaluation unit 112 comprises, for example, a comparator for comparing the measured voltage value with a reference value and means for adjusting the output capacity before the measurement is taken. The evaluation unit 112 also contains means for generating an output signal if the change in capacitance indicates that the blade 100 has contacted the electrical conductor 104 of the cable.

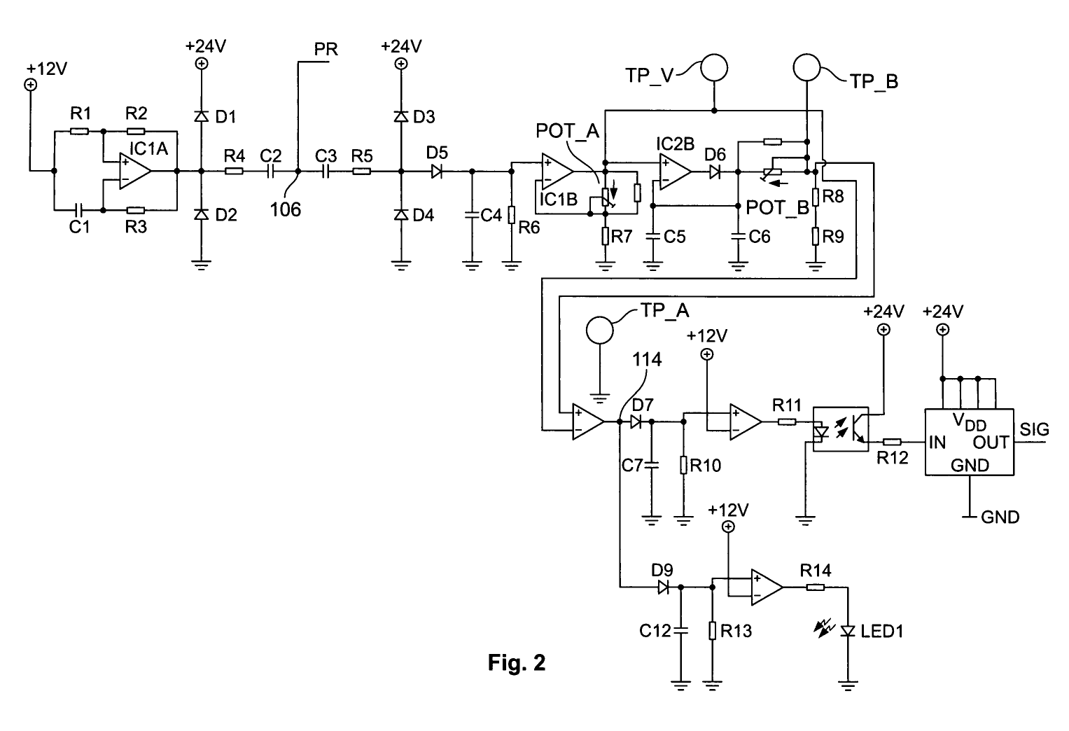

A first embodiment of a capacitive sensor unit for an insulation stripping device will be described with reference to FIGS. 2 to 7. This circuit is suitable for use in a complex cable finishing device, which performs insulation stripping and subsequent crimping. Instead of the crimping, one or more further processing steps, such as soldering, force fitting or mounting a plug connector, could also be provided.

A sinusoidal signal with a frequency of 57 kHz for example is generated as a base signal by the oscillator R1, R2, R3, C1, IC1A which functions as an A.C. voltage generator. According to the invention, the terminal indicated by PR is attached to two blades of the insulation stripping device. Before the actual measurement takes place, the basic capacitance is adjusted at the potentiometer POT_A. In the process, a particular voltage value must be set at the measuring point TP_A relative to ground. For example, in the present circuit, the resistance value of the potentiometer A is set in such a way that a voltage value of 22.0 V is measured at the measuring point TP_A in the resting state.

Furthermore, the sensitivity can be adjusted by means of the potentiometer POT_B, in that the voltage at the test point TP_B is set to a predetermined value. However, these two functions may also be performed automatically; this is particularly advantageous in an application with a portable crimping tool.

The amplifier IC1B amplifies the signal for measurement, which can be measured at the node point 106, and the comparator IC2B compares the measured capacitance with a reference. If the resulting difference exceeds the thresholds defined by the resistors R9 and R8, the circuit according to the invention emits, at the node point 114, an output signal, which is used by the present circuit in two ways. On the one hand, if contact of the blade with the conductor is detected, a stop signal is emitted at the output SIG, which stops a subsequent crimping process. Moreover, the LED LED1 is activated in such a way that the user can immediately recognise the fault and introduce counter measures. Alternatively or in addition, acoustic indicators may be provided. Holding circuits, which buffer a signal long enough for the respective functions to be carried out, may also be provided between the node 114 and the respective output element.

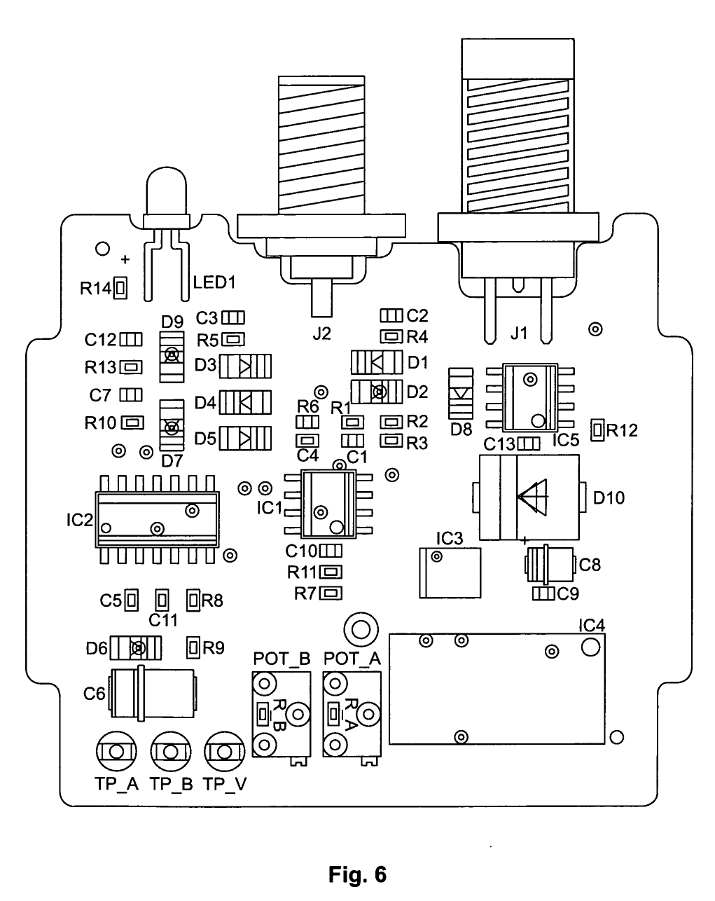

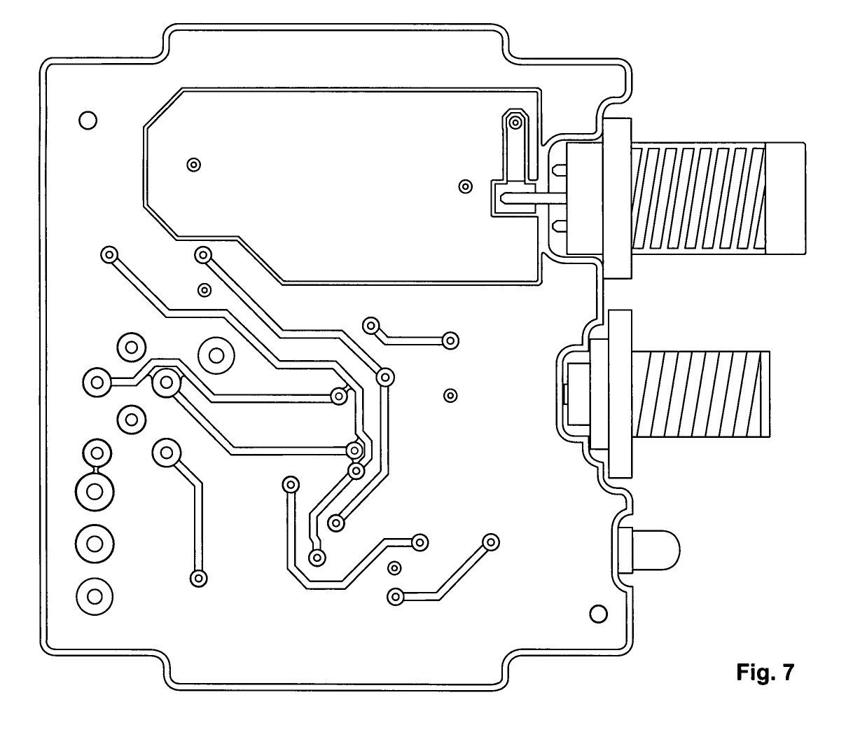

An example of a circuit board on which the circuit shown in FIGS. 2 to 5 may be constructed is shown in FIGS. 6 and 7.

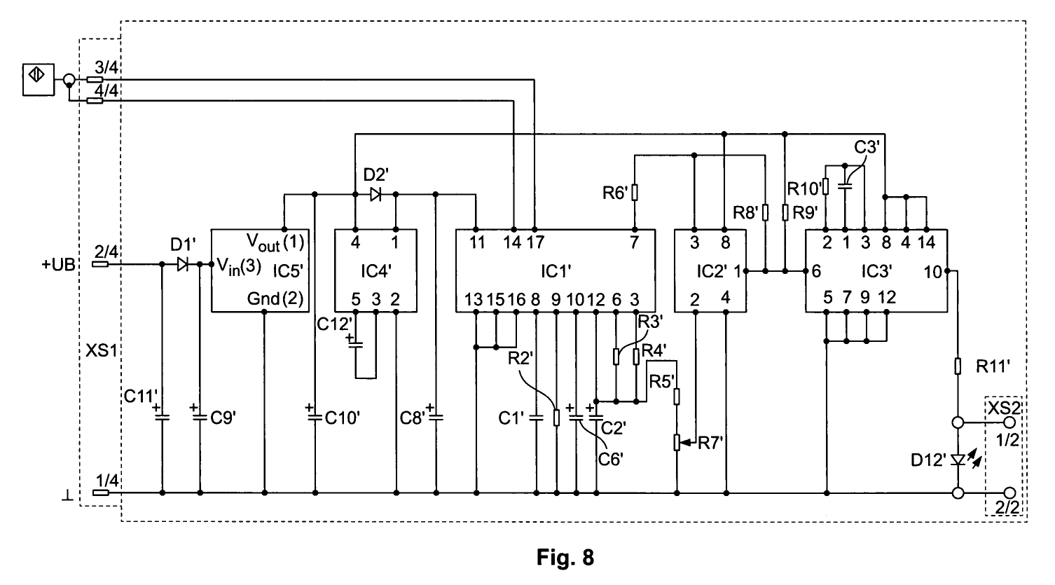

FIG. 8 shows an alternative embodiment, which in particular has further been optimized in regard to current consumption and construction size, in order to be used in a crimping tool.

In this case, the basic function corresponds to that of FIG. 2. The first two components IC5′ and IC4′ of the circuit are provided so that conventional batteries, with comparatively low battery voltage (i.e. four 1.5 V cells or a 9 V block), may be used. But on the other hand, a battery with higher voltage, at least 10 V of supply voltage, is also available for the oscillator. The component IC5′ is what is known as a “low drop” voltage regulator and the component IC4′ is a voltage doubler from 5 V to 10 V.

The component IC1′ contains both the oscillator and a circuit for automatically balancing the initial capacitance. Therefore, there is no need for an externally adjustable potentiometer. The component IC1′ also provides the output voltage, caused by the change of capacitance on the cutting device, at pin 7.

The component IC2′ is a comparator with which the responsiveness, i.e. the sensitivity at the blades, can be adjusted by means of the resistor R7. The component IC3′ is a timing element and also forms the control system for signalling, which in the present case is configured as an LED D12′. Moreover, a small buzzer, which is not shown in the present representation, may be attached to the free terminal XS2. The connections to the blades and to the battery are attached to the connector strip XS1.

An indication of the battery capacity and an automatic shut-off may additionally be provided in case a user forgets to switch off the device.

The circuit variant, shown in FIG. 8, may advantageously be used as an adjustment means for any present cable finishing devices that are no longer retrofittable, in which the circuit is provided in an external device and is connected to the connector strip XS1 with the blades.

In the case where the blade position is sufficiently unfavourable, i.e. the conductive wire of the cable is damaged when performing the insulation stripping process with the cutting device, a warning signal is emitted, and a user adjusts the blades until a warning is no longer emitted during the insulation stripping process. Accordingly, the adjustment process may be carried out in a very effective and timesaving manner.

1-15. (canceled)

16. An insulation stripping device for the partial removal of a cable insulation, comprising:
at least one electrically conductive blade for cutting through the cable insulation, and
a capacitive sensor unit, which is connected to the conductive blade and is constructed in such a way as to emit an output signal if the conductive blade contacts a electrical conductor of the cable.

17. The insulation stripping device according to claim 16, wherein the capacitive sensor unit comprises:
an A.C. voltage generator which is connected to the at least one blade,
a detector unit for detecting a capacitance between the at least one blade and a defined potential, and
an evaluation unit for generating the output signal as the function of the detected capacitance.

18. The insulation stripping device according to claim 16, wherein the output signal activates a warning light or a buzzer.

19. The insulation stripping device according to claim 16, wherein the sensor unit further comprises a comparator for comparing the detected capacitance with a reference value.

20. The insulation stripping device according to claim 16, wherein the at least one blade is electrically insulated from the insulation stripping device.

21. The insulation stripping device according to claim 17, wherein the evaluation unit further comprises a sensitivity regulator for adjusting the sensitivity.

22. The insulation stripping device according to claim 15, wherein the insulation stripping device is formed as a crimping tool.

23. The insulation stripping device according to claim 16, further comprising a crimping device as a cable finishing device, wherein the output signal is configured to stop the crimping process in the crimping device.

24. An adjustment means for an insulation stripping device for the partial removal of a cable insulation, wherein the insulation stripping device comprises at least one electrically conductive blade for cutting through the cable insulation,
wherein the adjustment means comprises a capacitive sensor unit, which is connected to an electrical conductor of the cable during the adjustment process and is thus constructed in such a way as to emit an output signal when the conductive blade contacts the electrical conductor of the cable.

25. The adjustment means according to claim 24, wherein the capacitive sensor unit comprises:
an A.C. voltage generator which is connected to the electrical conductor;
a detector unit for detecting a capacitance between the at least one blade and a defined potential; and
an evaluation unit for generating the output signal as a function of the detected capacitance.

26. The adjustment means according to claim 24, wherein the output signal activates a warning light or a buzzer.

27. The adjustment means according to claim 24, wherein the sensor unit further comprises a comparator for comparing the detected capacitance with a reference value.

28. The adjustment means according to claim 25, wherein the evaluation unit further comprises a sensitivity regulator for adjusting the sensitivity.

29. A method for finishing cables comprising the following steps:
stripping insulation from the cable by means of at least one electrically conductive blade;
monitoring a capacitance between the at least one blade and a defined potential; and
emitting an output signal if a change in the capacitance indicates that the blade has contacted a conductor of the cable.

30. An adjustment method for adjusting the blade position in an insulation stripping device comprising the following steps:
pre-adjusting the blade position;
providing an adjustment means having at least one electrically conductive blade for cutting through the cable insulation and a capacitive sensor unit;
connecting the adjustment means with at least one conductor of a cable;
stripping the insulation from the cable by means of the at least one electrically conductive blade; and
monitoring a capacitance between the at least one electrically conductive blade and a defined potential,
emitting an output signal if a change in the capacitance indicates a blade has contacted the conductor of the cable; and
readjusting the blade position until the output signal is no longer emitted.
